(19) United States
(12) Patent Application Publication
(10) Pub. No.: US 2006/0002341 A1
(43) Pub. Date: Jan. 5, 2006

(54) Methods and devices for scheduling the transmission of packets in configurable access wireless networks that provide Quality-of-Service guarantees

(76) Inventors: Yigal Bejerano, Springfield, NJ (US); Amit Kumar, New Delhi (IN)

Correspondence Address: HARNESS, DICKEY & PIERCE, P.L.C., P.O. Box 8910, Reston, VA, 20195, US

(21) Appl. No.: 10/879,063

(22) Filed: Jun. 30, 2004

(51) Int. Cl. H04B 7/212; H04L 12/56; H04Q 7/20

(52) U.S. Cl. 370/329; 370/345; 370/442; 370/395.4; 455/450

(57) ABSTRACT

A more energy efficient, medium access control (MAC) layer of a multi-hop wireless network is provided using scheduling techniques which reduce packet collisions, and therefore the need for packet re-transmissions, while ensuring both bandwidth and delay, Quality-of-Service (QoS) guarantees. The techniques are used in conjunction with the formation of a multi-hop, configurable access wireless network (CAN).

### BACKGROUND OF THE INVENTION

In a wireless network, the so-called medium access control (MAC) layer has a considerable effect on the amount of power or energy (collectively “energy”) consumed by each wireless station (e.g., wireless laptop computers) within the network. Energy considerations are almost always important. However, in static, multi-hop wireless networks, they are very important. In such networks, packets from a source wireless station may need to be routed through many intermediate stations before reaching their final destination station. If one of the stations along the path the packets must travel fails because it runs out of available energy (i.e., its batteries run down), the packets cannot be relayed through that station. This may prevent the packets (and their associated messages) from reaching their ultimate destination unless a suitable back-up path can be quickly identified and utilized.

It is desirable, therefore, to provide wireless stations within a static, multi-hop wireless network with a MAC layer that reduces the energy consumed by the stations.

One way to reduce the amount of energy consumed by each station is to reduce so-called packet re-transmissions. A packet needs to be re-transmitted, for example, if, during an earlier transmission, it was involved in a collision with another packet which prevented it from reaching its destination. If packet re-transmissions could be avoided or reduced this would allow wireless stations that are inactive or idle (i.e., not transmitting a packet) to remain in a so-called “sleep” mode longer because the station need not “wake up” (i.e., leave the sleep mode) and become active in order to re-transmit packets. However, this cannot be easily achieved when packets are transmitted in bursts, as opposed to in a continuous stream.

Even in wireless networks that transmit packets in a continuous stream (e.g., Time Division, Multiple Access networks), it has been difficult to reduce packet re-transmissions and still meet Quality of Service (QoS) guarantees. For example, so-called “packet scheduling” techniques have been implemented in an attempt to reduce re-transmissions. Schedules generated by conventional packet scheduling techniques avoid collisions, and thus the need for re-transmissions, by specifying the times when a wireless station is allowed to transmit packets so as to avoid collisions. While these techniques may reduce collisions and re-transmissions, they do so by sacrificing QoS guarantees related to delay. For example, one scheduling technique known as an edge coloring technique, has been able to reduce re-transmissions and provide QoS guarantees related to bandwidth, but has been unable to provide QoS guarantees related to delay.

It is further desirable, therefore, to provide wireless stations within a static, multi-hop wireless network with a MAC layer that not only reduces the energy consumed by the stations but also provides both bandwidth and delay QoS guarantees.

### SUMMARY OF THE INVENTION

We have recognized that a configurable access wireless network (CAN) architecture can be used to provide a more energy-efficient MAC layer to static, multi-hop wireless networks while still meeting bandwidth and delay related QoS guarantees. In our approach, time is divided into superframes. Each superframe consists of a plurality of slots, each slot having a duration substantially equal to the time required to transmit a single packet. Collision free operation is ensured by generating packet re-transmission or transmission (collectively referred to hereafter as “transmission”) schedules for each wireless station in the CAN such that, during any given slot assigned to a station, each station may transmit or receive a single packet, but not both.

Slots are assigned to each station by making use of a scheduling graph. Within each graph, a so-called Hamiltonian Cycle is identified. The cycle is used to identify those slots which should be assigned to each station (i.e., be a part of its schedule) to avoid collisions, and thus conserve energy, while at the same time providing both bandwidth and delay QoS guarantees.

The division of time into superframes, assignment of slots to stations and the generation of schedules may be carried out by a controller or the like.

### BRIEF DESCRIPTION OF THE DRAWINGS

FIG. 1 depicts a simplified illustration of a TDMA-based CAN according to an embodiment of the present invention.

FIG. 2(a) depicts a CAN according to another embodiment of the invention.

FIG. 2(b) depicts route selection for the CAN of FIG. 2(a).

FIG. 3(a) depicts a scheduling graph H(S,X) generated using an embodiment of a scheduling technique provided by the present invention that corresponds to the CAN in FIG. 2(a).

FIG. 3(b) depicts a possible Hamiltonian cycle that corresponds to the graph in FIG. 3(a).

### DETAILED DESCRIPTION OF THE INVENTION

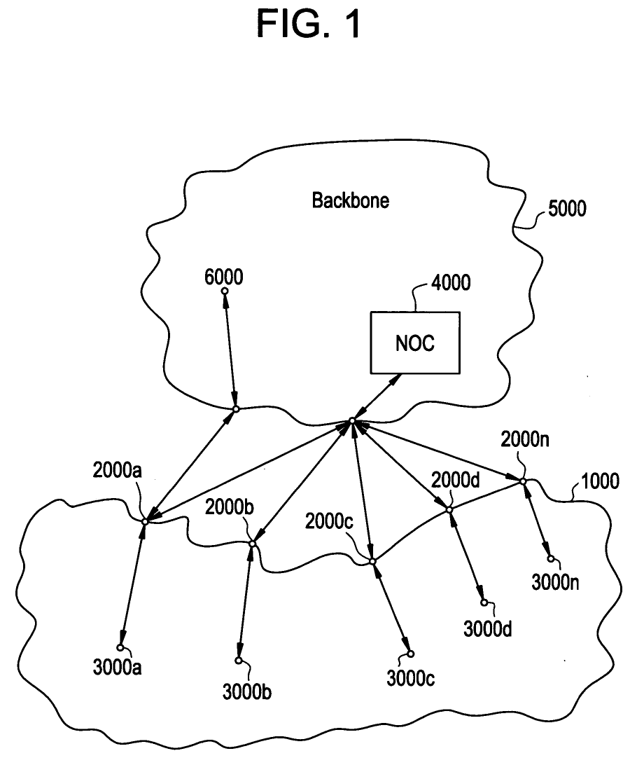

Referring now to FIG. 1, there is shown a simplified illustration of a TDMA-based CAN 1000 according to one embodiment of the present invention. As shown, CAN 1000 includes one or more access point stations (APs) 2000a,2000b, . . . 2000n and non-AP stations (“stations”) 3000a,3000b, . . . 3000n (where “n” is the last AP or station). In one embodiment of the present invention, CAN 1000 is connected to, and receives at least configuration and activation messages from an external controller 4000 referred to as a network operation center (“NOC”) or just controller. In an embodiment of the present invention, the NOC 4000 is operable to determine: the topology of CAN 1000; routing paths associated with each station; and packet transmission schedules associated with each station. Based on the routes and transmission schedules determined at a given point in time, the NOC 4000 is thereafter further operable to configure each wireless station 2000a,2000b, . . . 2000n and 3000a,3000b, . . . 3000n with its respective, so-determined routes and schedules.

The energy used by CAN 1000 is reduced as compared to conventional multi-hop wireless networks in part because the NOC 4000 is now responsible for both routing and scheduling decision-making; these operations are no longer carried out by an individual station as is the case in existing, multi-hop wireless networks. This greatly reduces the number of operations and overhead required by each station. Such reductions lead to a savings in valuable energy resources.

Placing scheduling decision-making in an NOC also allows for the creation and implementation of more efficient scheduling techniques that may minimize packet collisions, and thus packet re-transmissions, further reducing the energy required by each station.

Backtracking somewhat, as indicated before, prior to scheduling the transmission of packets, the topology of CAN 1000 and the routes over which packets in CAN 1000 will travel should be identified. Co-pending U.S. patent application Ser. Nos. ______ and ______ both incorporated herein as if set forth in full herein, disclose some techniques for determining the topology of a CAN and identifying primary routing paths for a CAN, respectively. Once the topology is determined and if the primary routing paths have been identified and forwarded to the stations in the network, it then makes sense to generate packet transmission schedules.

The present invention provides packet transmission scheduling techniques that are based on finding a Hamiltonian cycle in an auxiliary graph, referred to as a scheduling graph, to ensure both bandwidth and delay QoS guarantees. Because both bandwidth and delay QoS guarantees are ensured, the scheduling techniques provided by the present invention may be used to generate packet transmission schedules for applications that involve real-time traffic conditions, e.g., wireless surveillance networks, wireless disaster recovery networks, wireless residential/community-based networks and the like.

The scheduling of packets in a TDMA, static, multi-hop wireless network can be modeled as follows. If the transmission time of a single packet is denoted by the symbol Δ, and the bandwidth demand, d_{υ}, of a station υ is defined by the number of packets that station υ originates during a given unit of time, then, in one embodiment of the present invention, a time period can be divided into superframes, each having a duration of one time unit and consisting of a plurality of W slots of duration Δ, enumerated from 1 to W.

To satisfy bandwidth demands, d_{υ}a number of slots may be allocated to every station v ε U. In one embodiment of the present invention, a slot assignment technique specifies the slot numbers during which each station υ is allowed to originate new packets (“a demand”) in each superframe. This technique substantially reduces packet collisions provided it satisfies the following scheduling constraint: during any slot, a station may only transmit or receive a single packet, but not both. Said another way, a packet schedule incorporating slot assignments generated by the present invention is deemed feasible if it determines for each slot s ε [1 . . . W] a set of transmitter-receiver pairs {(u,υ)|(u,υ) ε E} that satisfy this scheduling constraint.

In reality, the generation of such schedules is a very difficult task (referred to as an NP-hard problem) to solve. To simplify the solution to such a problem, the following discussion focuses on a technique that provides a solution that can be used to generate packet transmission schedules for upstream traffic flows such as those found in wireless surveillance networks, for example. It should be understood, however, that a solution that yields schedules for downstream flows may be derived using a similar technique.

To satisfy bandwidth requirements, while minimizing packet propagation delays as much as possible, the techniques provided by the present invention must also satisfy both shortest path and packet forwarding constraints.

The shortest path constraint ensures that each packet is routed along a shortest path from the packet's originator to its nearest AP. Though this limitation on route selection may reduce the lifetime of a network, practically speaking, the reduction is not severe.

The packet forwarding constraint ensures that each station that receives a packet forwards it on to a next station assigned to a successive slot.

If these two constraints are met, the propagation time of a packet can be calculated by multiplying the path length times a slot duration, i.e., L(Pᵥ)·Δ, where L(Pᵥ) is the length of the shortest path from station υ to its serving AP.

Initially, to satisfy both constraints, the “problem statement” that represents how to formulate appropriate routes and transmission schedules, itself must be reformulated to meet both constraints. As indicated before, this problem statement is an NP-hard problem to solve. Proof of this is not necessary for an understanding of the present invention and has, therefore, been omitted. That said, the present inventors discovered that approximation techniques which provide approximate solutions could be used to solve this NP-hard problem.

Before presenting a detailed discussion of the techniques provided by the present invention, it should be understood that each technique involves a number of intermediate steps. Initially, each technique first requires the identification of routing paths where each path represents a shortest path from an originating wireless station to a nearest AP and it is assumed that all traffic flows from such a station to the nearest AP. Additionally, all stations associated with this nearest AP are assumed to be along this shortest path. After the routing paths have been identified, these paths are used to create a “clustered” model of a network, where a cluster of stations may be defined as a set of stations which contains a single AP. Using such a model, traffic may be routed from a station to the single AP without leaving the cluster and a station along a shortest path may also be included in such a cluster. Thereafter, a packet transmission scheduling problem is formulated.

As will be discussed in greater detail below, it was upon studying this formulation that the present inventors also discovered that the scheduling problem could be solved by recognizing that it could be formulated as a station ordering problem. Again, to verify this the inventors developed a proof which has been omitted because it is unnecessary for an understanding of the present invention.

In a further embodiment of the invention, therefore, the present invention, generally speaking, provides for the generation of a model to solve the station ordering problem. In more detail, a model of the station ordering problem can be represented by a scheduling graph, H(S,X). Once the graph is generated, a Hamiltonian cycle can be identified from the graph. The cycle which is identified can then be used to generate the order (i.e., schedule) in which stations may transmit (or receive a packet) and still satisfy the above-mentioned forwarding constraint.

A more formal representation of the problems needed to be solved in order to identify and generate acceptable packet transmission schedules follows where route selection is discussed first, followed by schedule generation.

To begin with, the present invention provides for routing techniques that meet the shortest path constraint. One such technique can be modeled by dividing a graph G(V,E) into |A| clusters, such that each cluster of stations C ⊂ V contains a single AP a ε A. Each station v ε U is associated with its nearest AP. Ties are broken in a load-balanced manner that maintains station connectivity, i.e., a station υ is associated with an AP a only if all the stations in one of its shortest paths to a are associated with a. It should be noted that the details concerning how the clusters are generated are not necessary for an understanding of the present invention and have, therefore, been omitted.

Next, for each cluster C, routes that satisfy the shortest path constraint are independently identified by constructing a directed layer graph that contains an edge (e.g., link) only if the edge is included in one of the shortest paths from an AP to any other station. By applying a route selection technique to this graph, an integral solution is obtained where the identified routes are along the shortest paths.

Once routes have been identified, it then makes sense to model a scheduling problem that can eventually be used to generate transmission schedules. On example of a model for the scheduling problem is as follows. Consider a cluster of stations C with a single AP a and a demand d_{υ} for each station υ ε C−{a}. Moreover, let {Pᵥ}, v ε C−{a}, be a route selection that satisfies the shortest path constraint, let L(P_{υ}) denote the length of path P_{υ} and let a superframe be defined as a plurality of W slots. Those skilled in the art will realize that an AP can receive a single packet during any slot. Thus, it can be said that a feasible schedule is one that ensures that a single packet is scheduled to be received by an AP during each slot.

In more detail, a slot k is said to be allocated to station υ if a packet of station υ is scheduled to arrive at the AP during slot k. Applying the packet forwarding constraint mentioned above leads to a result that when slot k is allocated to station u, the station is allowed to initiate (e.g., generate a packet for transmission) a new packet at slot (k−L(P_{υ})+1) mod W. It was this model that lead the inventors to discover a number of properties, discussed briefly below, which in turn lead to the discovery that the scheduling problem could be formulated as a station ordering problem.

Property 1: Let Qₖ ⊂ C be the set of all stations at a distance k from the AP a, termed the k-layer, and consider a feasible packet schedule that satisfies the shortest path and forwarding constraints. Then, at any given slot there is at most one transmitting station and one receiving station at each layer Qₖ.

Furthermore, a packet schedule is feasible if and only if it satisfies the following:

Property 2: Given a set of paths P_{υ} along the shortest paths to an AP, a packet schedule is feasible and satisfies the forwarding constraint if and only if it satisfies the following two conditions: (i) each slot is allocated to a single station; (ii) for every pair of successive slots (the first and last slots are also considered successive) allocated to any stations u, v ε C−{a}, the path P_{υ} and Pᵤ are disjoint beside the access-point, i.e., Pᵥ ∩ Pᵤ={a}.

To verify the just stated properties, the present inventors developed proofs. However, because these proofs are not needed for an understanding of the present invention, they have been omitted.

Proofs aside, the discovery of the above-stated properties, as indicated before, lead the present inventors to discover that the scheduling problem could be formulated as a station ordering problem.

To solve such a problem, the inventors again turned to a model. A station ordering problem can be modeled by a scheduling graph H(S,X) with |S|=W vertices that represent superframe slots and a set of arcs X. S is divided into |C| disjoint sets such that each set, denoted by S_{υ}, is associated with a single station v ε C and contains d_{υ} vertices, where

$${d}_{a} = W - {\sum }_{v ∈ C} {d}_{v} .$$

For every vertex s ε S, let υ(s) denote its associated station v ε C. Two vertices s₁, s₂ ε S are connected by an arc (s₁, s₂) ε X only if Pᵥ₍ₛ_{₁}₎ and Pᵥ₍ₛ_{₂}₎ are disjoint beside the AP, i.e. Pᵥ₍ₛ_{₁}₎ ∩ Pᵥ₍ₛ_{₂}₎={a}. Such an arc indicates that two successive slots can be allocated to stations v(s₁) and v(s₂). The scheduling problem (or station ordering problem) can then be re-formulated as follows.

Given a scheduling graph H(S,X) the present invention then finds a vertex ordering K={s₁, . . . , s_{w}} that induces a Hamiltonian cycle in H using graph H(S,X) such that a slot sᵢ is allocated to a station υ(sᵢ).

In one embodiment of the present invention, a Hamiltonian cycle is identified from the scheduling graph as follows.

Initially, it can be assumed that a minimal degree of a scheduling graph is at least |S|/2. This is a reasonable assumption for a wireless network that provides considerable path diversity.

Let N(s) be the set of neighbors of vertex s ε S. A path P={s₁,s₂. . . , sₖ} is said to be maximal if both N(s₁) and N(sₖ) are included in P. This technique, in part, utilizes the following property whose proof is known in the art.

Property 3: Let P={sₗ,s₂. . . , sₖ} be a maximal path in H. Then there is an index 1<j≦k such that the arcs (sₗ,sⱼ) and (sⱼ₋₁,sₖ) are included in X. Thus, H contains the cycle K={s_{1,}s_{2,} . . . sⱼ₋₁,sₖ,sₖ₋₁, . . . , sⱼ,sₗ}.

Initially, to identify a Hamiltonian cycle the techniques provided by the present invention find a maximal path P, starting with a path with a single arc and then add arcs to P as much as possible. From Property 3, it can be shown that there is a cycle K that contains all stations of P. If K is not a Hamiltonian cycle then there is a vertex sᵢ ε K that has neighbors not in K. Next the arc (sⱼ,sⱼ₊₁) is removed from K to obtain a path P′. Then, P′ is extended as much as possible to find a cycle that contains all the stations of P′. This process continues until a Hamiltonian cycle is found.

In sum, a Hamiltonian cycle may be identified based on a scheduling graph representative of a cluster, C, of stations such that each station, υ, in the cluster is connected via one or more of the shortest paths to an access point, a, also in the cluster that meets an aggregated bandwidth demand Σ_{v ε C-{a}}dᵥ≦W/2, where d_{υ} is the demand of every station υ in C and W is a wireless link capacity. Once a cycle is identified, it may be used to generate packet transmission schedules that allocate one or more slots to one or more of the stations while still satisfying the shortest path and packet forwarding constraints.

When a particular scheduling graph does not satisfy the degree requirement(s) and a Hamiltonian cycle is not found, the present invention provides for the modification of the scheduling graph in question by adding more slots to a superframe (up to 2-W slots) or by relaxing the aggregated demand (to be at most W/2) until a cycle is identified. This ensures a graph that satisfies the degree requirement and at least half of the required bandwidth. Therefore, it follows that the scheduling techniques provided by the present invention are associated with a 2-approximation factor for general scheduling graphs.

Once a cycle is identified by adding slots or by modifying a graph, packet transmission schedules can then be generated for one or more wireless stations in a TDMA network that allows the transmission of packets during each original and additional slot (in the case where slots are added) or during each slot according to the so-identified cycle.

Most of the features and functions of the present invention described above may be carried out by the NOC or controller 4000 which may include one or more software programs for storing and executing instructions necessary to carry out the techniques of the present invention.

After the NOC or controller 4000 has generated the packet transmission schedules it may be further operable to forward these schedules to one or more of the stations 2000a,2000b, . . . 2000n and 3000a,3000b, . . . 3000n, in which case the schedules are used by the stations to control the transmission of packets, or are otherwise used by the NOC or controller 4000 to control the operation of these stations. In either case, the schedules ensure that each station is operable to transmit only a single packet during each slot assigned to each of the one or more stations to reduce collisions between transmitted packets, each slot having been allocated by a Hamiltonian cycle, identified based on a scheduling graph representative of a cluster, C, of wireless stations in the CAN, TDMA network 1000 such that each station, υ, in the cluster is connected via one or more shortest paths to an access point, a, also in the cluster that meets an aggregated bandwidth demand Σ_{v ε C-{a}}dᵥ≦W/2.

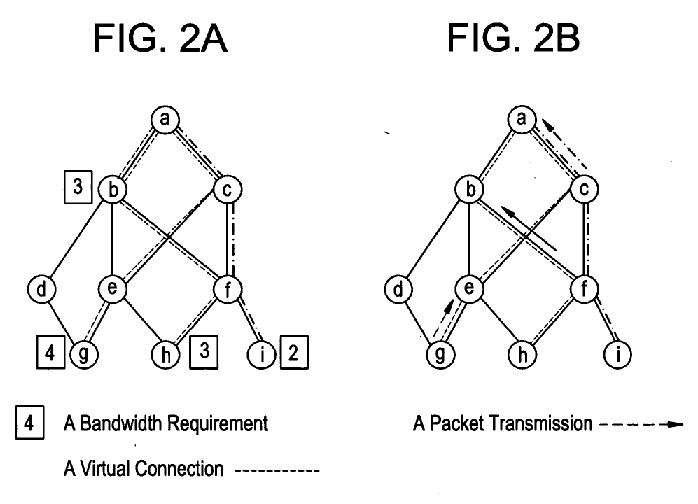

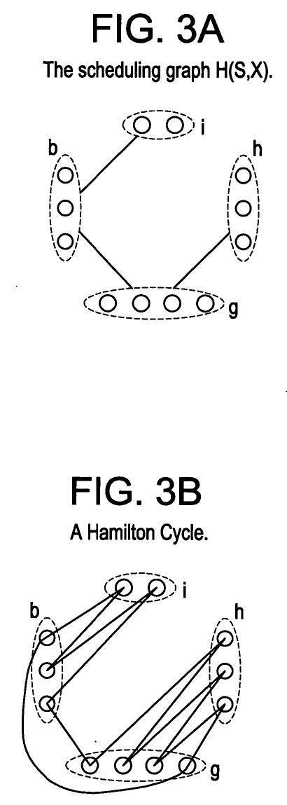

FIG. 2(a) depicts another example of a CAN which can be formed in accordance with the present invention, while FIG. 2(b) depicts a route selection based on the CAN in FIG. 2(a). As shown, the shortest paths are P_{b}={b,a},P_{g}={g,e,c,a},Pₕ={h,f,b,a},Pᵢ={i,f,c,a} and the bandwidth demands are d_{b}=3, d_{g}=4, dₕ=3 and dᵢ=3. If it is assumed that W=12, FIG. 3(a) depicts a scheduling graph H(S,X) and FIG. 3(b) a possible Hamiltonian cycle that correspond to the CAN in FIGS. 2(a) and (b). A possible sequence of arriving slots of a packet to an AP a derived from FIGS. 3(a) and 3(b) is {g,h,g,b,I.b.I.b.g.h.g.h}.

Having set forth some examples of the present invention, others may be envisioned within the scope of the present invention which is better defined by the claims which follow.

We claim:

1. A method for scheduling the transmission of packets in a configurable, Time Division, Multiple Access (TDMA) wireless network that ensures both bandwidth and delay Quality-of-Service (QoS) guarantees comprising:
dividing a time period into one or more superframes, each superframe consisting of a plurality of slots, each slot having a duration substantially equal to the time required to transmit a single packet; and
generating a packet transmission schedule for one or more wireless stations in the TDMA network such that only a single packet is transmitted during each slot assigned to each of the one or more stations to reduce collisions between transmitted packets.

2. The method as in claim 1 further comprising generating the schedules to provide both bandwidth and delay, QoS guarantees.

3. The method as in claim 1 further comprising generating a scheduling graph.

4. The method as in claim 3 further comprising:
identifying a Hamiltonian cycle in the scheduling graph; and
generating a schedule for one or more wireless stations in the TDMA network that allocates one or more slots to the one or more stations according to the identified cycle.

5. The method as in claim 1 further comprising:
identifying a Hamiltonian cycle, based on a scheduling graph representative of a cluster, C, of stations in the TDMA network such that each station, υ, in the cluster is connected via one or more shortest paths to an access point, a, also in the cluster that meets an aggregated bandwidth demand Σ_{v ε C-{a}}dᵥ≦W/2, where d_{υ} is the demand of every station υ in C and W is a wireless link capacity; and
generating packet transmission schedules for the one or more wireless stations in the TDMA network that allocate one or more slots to the one or more stations based on the identified cycle.

6. The method as in claim 5 further comprising:
modifying a scheduling graph by adding one or more additional slots to the superframe;
identifying a Hamiltonian cycle in the modified scheduling graph; and
generating packet transmission schedules for the one or more wireless stations in the TDMA network that allows the transmission of packets during each original and additional slot according to the identified cycle.

7. The method as in claim 5 further comprising:
modifying a scheduling graph by relaxing the aggregate bandwidth demand Σ_{v ε C-{a}}dᵥ≦W/2;
identifying a Hamiltonian cycle in the modified scheduling graph; and
generating packet transmission schedules for the one or more wireless stations in the TDMA network that allows the transmission of packets during each slot according to the identified cycle.

8. A controller, for generating one or more packet transmission schedules for one or more wireless stations in a configurable TDMA wireless network that ensures both bandwidth and delay QoS guarantees, operable to:
divide a time period into one or more superframes, each superframe consisting of a plurality of slots, each slot having a duration substantially equal to the time required to transmit a single packet; and
generate a packet transmission schedule for one or more wireless stations in the TDMA network such that only a single packet is transmitted during each slot assigned to each of the one or more stations to reduce collisions between transmitted packets.

9. The controller as in claim 8 further operable to generate the schedules to provide both bandwidth and delay, QoS guarantees.

10. The controller as in claim 8 further operable to generate a scheduling graph.

11. The controller as in claim 10 further operable to:
identify a Hamiltonian cycle in the scheduling graph; and
generate a schedule for one or more wireless stations in the TDMA network that allocates one or more slots to the one or more stations according to the identified cycle.

12. The controller as in claim 8 further operable to:
identify a Hamiltonian cycle, based on a scheduling graph representative of a cluster, C, of stations in the TDMA network such that each station, υ, in the cluster is connected via one or more shortest paths to an access point, a, also in the cluster that meets an aggregated bandwidth demand Σ_{vεC-{a}}dᵥ≦W/2, where d_{υ} is the demand of every station υ in C and W is a wireless link capacity; and
generate packet transmission schedules for the one or more wireless stations in the TDMA network that allocate one or more slots to the one or more stations based on the identified cycle.

13. The controller as in claim 12 further operable to:
modify a scheduling graph by adding one or more additional slots to the superframe;
identify a Hamiltonian cycle in the modified scheduling graph; and
generate packet transmission schedules for the one or more wireless stations in the TDMA network that allows the transmission of packets during each original and additional slot according to the identified cycle.

14. The controller as in claim 12 further operable to:
modify a scheduling graph by relaxing the aggregate bandwidth demand Σ_{vεC-{a}}dᵥ≦W/2;
identify a Hamiltonian cycle in the modified scheduling graph; and
generate packet transmission schedules for the one or more wireless stations in the TDMA network that allows the transmission of packets during each slot according to the identified cycle.

15. One or more wireless stations comprising a configurable, TDMA wireless network, each station operable to transmit only a single packet during each slot assigned to each of the one or more stations to reduce collisions between transmitted packets.

16. The one or more wireless stations as in claim 15 wherein each station is further operable to transmit the single packet during an allocated slot associated with an identified Hamiltonian cycle.

17. The one or more wireless stations as in claim 16, wherein the Hamiltonian cycle is identified based on a scheduling graph representative of a cluster, C, of wireless stations in the TDMA network such that each station, υ, in the cluster is connected via one or more shortest paths to an access point, a, also in the cluster that meets an aggregated bandwidth demand Σ_{vεC-{a}}dᵥ≦W/2, where d_{υ} is the demand of every station υ in C and W is a wireless link capacity.
